(19) United States
(12) Patent Application Publication
(10) Pub. No.: US 2007/0057766 A1
(43) Pub. Date: Mar. 15, 2007

(54) Radio frequency identification security device for electronic data

(76) Inventors: Ming-Hung Huang, Hsinchu (TW); Jian-Shiang Chen, Hsinchu (TW); Shi-Mon Chen, Hsinchu (TW); Shi-Jay Weng, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/225,117

(22) Filed: Sep. 14, 2005

(51) Int. Cl. H04L 9/32

(52) U.S. Cl. 340/5.74; 340/5.61

(57) ABSTRACT

The present invention discloses a radio frequency identification security device for electronic data, wherein once the user with an electronic key enters into the scanned area of an electronic lock, a security software is initiated, and the user will be allowed to read the protected data in a storage device; once the user leaves the scanned area of the electronic lock, the storage device is instantly locked. Therefore, the present invention can promote the security of data and protect the data against being stolen by an unauthorized person.

### BACKGROUND OF THE INVENTION

1. Field of the Invention

The present invention relates to a radio frequency identification security device, particularly to a radio frequency identification security device for electronic data.

2. Description of the Related Art

Together with the progress of science and technology, electronic devices have replaced handwritten documents to record data. Therefore, the security of electronic data becomes very important in modern society.

In the conventional technology of securing electronic data, such as securing data in a computer, the computer is equipped with a keyhole; when the user is leaving the computer, a key is fitted into the keyhole to lock the computer lest the data be stolen; when the user returns to his computer, he has to fit the key into the keyhole again to unlock the computer in order to work with the computer.

However, the abovementioned method is troublesome. What is worse, in a state of emergency, the user can be too hurried to fit the key into the keyhole to lock the computer; thus, the data can be stolen then. Therefore, in addition to the trouble of fitting the key into the keyhole, the data security can be endangered sometime.

In re the abovementioned problems, the present invention proposes a radio frequency identification security device for electronic data in order to overcome the problems.

### SUMMARY OF THE INVENTION

The primary objective of the present invention is to provide a radio frequency identification security device for electronic data, which comprises an electronic key, an electronic lock and a security software, wherein in contrast to the conventional lock device that the user has to fit a key into a keyhole to open the lock, via the combination device of those three components mentioned above, the user within the scanned area of the electronic lock is allowed to read the protected data in a storage device just by carrying about the electronic key to initiate the security software, and once the user leaves the scanned area of the electronic lock, the storage device is instantly locked.

Another objective of the present invention is to provide a radio frequency identification security device for electronic data, which can promote the security of the user's electronic device, and can prevent the data from being read by an unauthorized person. Further, the security software can prevent the electronic key code from being duplicated via a convert/concealed reading device lest the security system be easily broken through.

To achieve the aforementioned objectives, the present invention provide a radio frequency identification security device for electronic data, which comprises an electronic device, an electronic key, and an electronic lock, wherein the electronic device has a built-in security software and a storage device for storing data; the electronic key is used to store an electronic key code and perform the non-contact exchange transmission of energy and signal; the electronic lock has a plug-and-play function, can acquire energy, perform data exchange with the storage device, and send energy and signal to the electronic key to enable the electronic key to work.

To enable the objectives, technical contents, characteristics, and accomplishments of the present invention to be more easily understood, the embodiments of the present invention is to be described below in cooperation with the attached drawings.

### BRIEF DESCRIPTION OF THE DRAWINGS

FIG. 1 is a schematic diagram of the radio frequency identification security device for electronic data according to one embodiment of the present invention.

FIG. 2 is the circuit block diagram of the electronic key of the present invention.

FIG. 3 is the circuit block diagram of the electronic lock of the present invention.

### DETAILED DESCRIPTION OF THE INVENTION

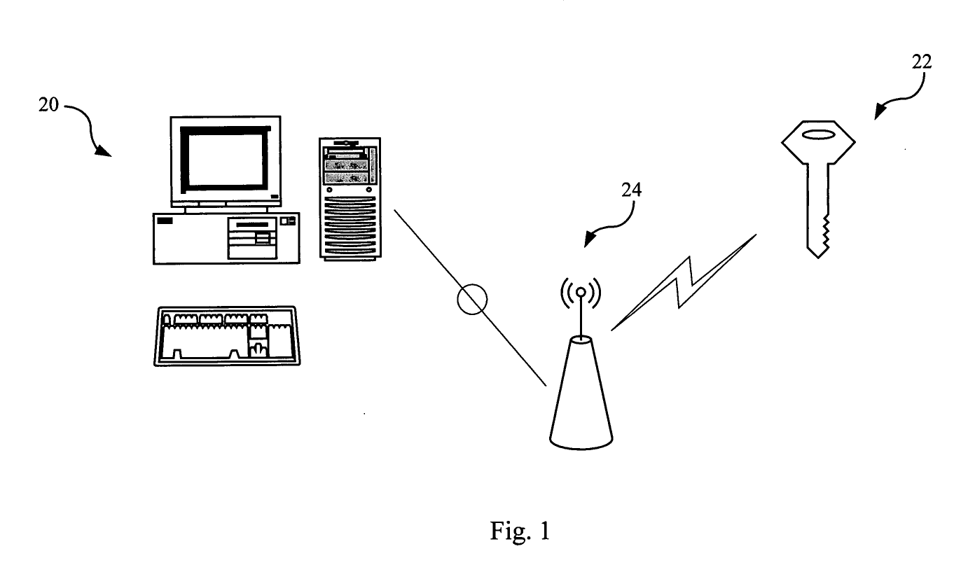

As shown in FIG. 1, the radio frequency identification security device for electronic data according to one embodiment of the present invention comprises: an electronic device 20, such as a computer, having a built-in security software and a storage device for storing data; an electronic key 22, used to store an electronic key code and perform the non-contact exchange transmission of energy and signal; an electronic lock 24, having a plug-and-play function, and used to acquire energy, perform data exchange with the storage device and send energy and signal to the electronic key 22 to enable the electronic key 22 to work.

The electronic key 22 utilizes a magnetic coupling or a microwave technology to perform the non-contact exchange transmission of energy and signal. The electronic lock 24 utilizes a magnetic coupling technology to transmit energy to the electronic key 22.

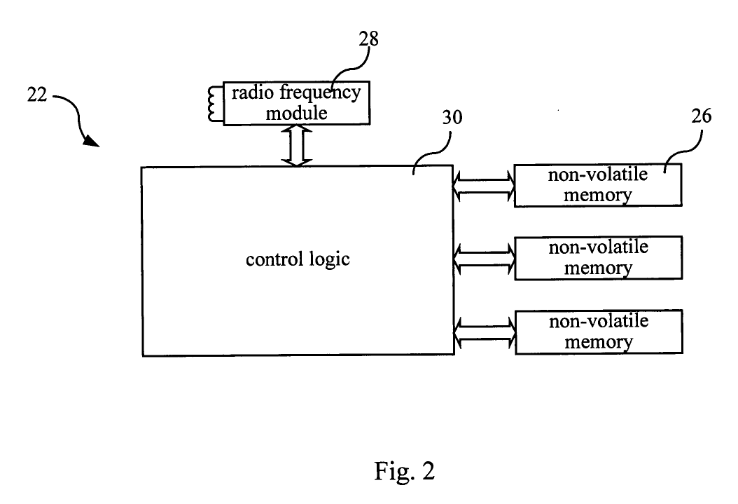

Refer to FIG. 2 the circuit block diagram of the electronic key 22. The electronic key 22 comprises at least one non-volatile memory 26, such as a Read Only Memory (ROM), and a radio frequency identification (RFID) tag device, i.e. a radio frequency module 28; both are interconnected via a control logic 30; the non-volatile memory 26 is used to store the electronic key code, and the radio frequency module 28 is used to perform the non-contact exchange transmission of energy and signal.

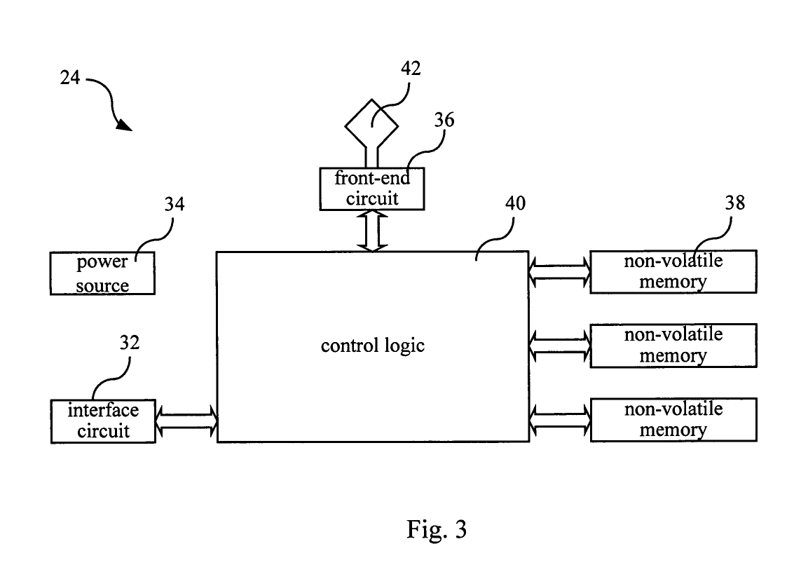

Refer to FIG. 3 the circuit block diagram of the electronic lock 24. The electronic lock 24 comprises: an interface circuit 32, coupled to the electronic device 20, such a plug-and-play interface; a power source 34; a front-end circuit 36; and at least one non-volatile memory 38, such as a Read Only Memory (ROM). The interface circuit 32, the front-end circuit 36, and the non-volatile memory 38 are interconnected via a control logic 40. The front-end circuit 36 is further coupled to an antenna 42. The interface circuit 32 is coupled to the electronic device 20 and used to acquire energy and perform data exchange with the storage device. The non-volatile memory 38 is used to store the electronic key code. When the electronic key 22 is within a given reach of the electronic lock 24, the radio frequency module 28 receives the power from the antenna 42, which enables the identification data stored in the non-volatile memory 26, such as the electronic key code, to be responded to the electronic lock 24. After the user has entered a password to the electronic device 20, the electronic device 20 will be unlocked.

The radio frequency identification security device for electronic data of the present invention operates as follows: once the electronic key 22 leaves the scanned area of the electronic lock 24, the security software automatically locks the electronic device 20 lest the data inside the storage device be accessed, and once the electronic key 22 enters into the scanned area of the electronic lock 24, the electronic key code is input to the electronic device 20 to initiate the security software so that the data inside the storage device can be accessed.

In summary, the present invention proposes a radio frequency identification security device for electronic data, which comprises an electronic key, an electronic lock and a security software. Once the user carrying about the electronic key enters into the scanned area of the electronic lock, the security software is initiated, and then the user can read the protected data inside storage device; once the user leaves the scanned area of the electronic lock, the electronic device is locked. Thus, the present invention can prevent the protected data inside the storage device from being read by an unauthorized person. Further, the security software can prevent the electronic key code from being duplicated via a convert/concealed reading device lest the security system be easily broken through. Therefore, the data security is promoted by the present invention.

Those described above is to exemplify the present invention with the embodiments in order to enable the person skilled in the art to understand, make, and use the present invention, but not to limit the scope of the present invention. Any equivalent modification and variation according to the spirit of the present invention disclosed herein is to be included within the scope of the present invention.

What is claimed is:

1. A radio frequency identification security device for electronic data, comprising an electronic device having a built-in security software and a storage device to store data, and further comprising:
an electronic key, used to store an electronic key code and perform non-contact exchange transmission of energy and signal; and
an electronic lock, having a plug-and-play function, and used to acquire energy, perform data exchange with said storage device, and send said energy and said signal to said electronic key to enable said electronic key to work.

2. The radio frequency identification security device for electronic data according to claim 1, wherein once said electronic key leaves the scanned area of said electronic lock, said security software locks said electronic device lest the data inside said storage device be accessed; once said electronic key enters into the scanned area of said electronic lock, a user inputs said electronic key code to said electronic device to initiate said security software so that the data inside storage device can be accessed.

3. The radio frequency identification security device for electronic data according to claim 1, wherein said electronic key utilizes a magnetic coupling or a microwave technology to perform said “non-contact exchange transmission of energy and signal”.

4. The radio frequency identification security device for electronic data according to claim 1, wherein said electronic lock utilizes a magnetic coupling technology to transmit said energy to said electronic key.

5. The radio frequency identification security device for electronic data according to claim 1, wherein said electronic device is a computer.

6. The radio frequency identification security device for electronic data according to claim 1, wherein said electronic key comprises at least one non-volatile memory and a radio frequency identification tag device; said non-volatile memory is used to store said electronic key code, and said radio frequency identification tag device is used to perform non-contact exchange transmission of energy and signal.

7. The radio frequency identification security device for electronic data according to claim 1, wherein said electronic lock is equipped with an interface circuit that is coupled to said electronic device and has a plug-and-play function and is used to acquire energy and perform said data exchange with said storage device.
